(19) United States
(12) Patent Application Publication
(10) Pub. No.: US 2015/0184733 A1
(43) Pub. Date: Jul. 2, 2015

(54) MOTOR VEHICLE DRIVE TRAIN COMPRISING A HYDRODYNAMIC RETARDER

(71) Applicant: Voith Patent GmbH, Heidenheim (DE)

(72) Inventors: Achim Menne, Crailsheim (DE); Tilman Huth, Satteldorf (DE); Dieter Laukemann, Crailsheim (DE); Werner Koch, Deggingen (DE); Werner Klement, Heidenheim (DE); Martin Becke, Ulm (DE)

(21) Appl. No.: 14/359,468

(22) PCT Filed: Dec. 7, 2012
(86) PCT No.: PCT/EP2102/074720

§ 371 Date: May 20, 2014

(30) Foreign Application Priority Data
Dec. 9, 2011 (DE) 10 2011 120 619.5

(51) Int. Cl. F16H 47/06; B60T 10/02; B60T 1/087

(52) U.S. Cl. CPC F16H 47/06; B60T 1/087; B60T 10/02

(57) ABSTRACT

The invention concerns a motor vehicle drive train,
having a drive motor and drive wheels, whereas the drive wheels are driven by the drive motor via a main branch;
having a hydrodynamic retarder, comprising a rotating rotor and a stator or a rotating rotor and a counter-rotor rotating in opposite direction to the rotor, which together form a working chamber which is filled or can be filled with a working medium;
having a separating clutch, by means of which the rotor of the hydrodynamic retarder can be disengaged from a driving power flow in the drive train.

The invention is characterised in that that the hydrodynamic retarder is connected to the main branch via an at least two-stage transmission, comprising at least one intermediate shaft and a rotor shaft, whereas the rotor shaft drives or carries the rotor and the intermediate shaft with the main branch forms at least one first gear ratio and with the rotor shaft at least one second gear ratio, and the separating clutch is positioned on the intermediate shaft.

The present invention concerns a motor vehicle drive train having a hydrodynamic retarder, in detail according to the preamble of claim 1.

Hydrodynamic retarders have proven themselves as wear-free continuous brakes in motor vehicle drive trains, in particular in lorries. The prerequisite for utility vehicle manufacturers to accept hydrodynamic retarders is however that the no-load losses of such hydrodynamic retarders are minimal in non-braking mode. Different measures have hence been provided so far to reduce the no-load losses in non-braking mode. Said measures include so-called ventilation plates which in non-braking mode are introduced into the gap between the rotor and the stator, to prevent any circular flow of air or of a mixture of air and residual working medium. Other measures consist in pulling out the rotor from the stator when passing from braking operation to non-braking operation or vice versa, also providing that the build-up of unwanted circular flow between rotor and stator is prevented. A more expensive solution consists in mechanical disengagement of the rotor from the drive train in non-braking mode so that the rotor comes to a standstill.

In particular, the last-mentioned solution sounds quite promising inasmuch a circular flow in the working chamber can be avoided reliably but this solution has required so far considerable construction space. It should also be noted that the disengagement of the rotor of the hydrodynamic retarder usually takes place just before the rotor, whereas also in non-braking mode additional masses, which do not exist in embodiments without hydrodynamic retarder, must rotate. It had been impossible until now to offer a solution to a utility vehicle manufacturer through which an existing mechanical retarder which cannot be disengaged can be replaced with a retarder which can be disengaged, without substantially modifying the system environment in the area of the retarder.

The object of the present invention is to offer a motor vehicle drive train, in which a hydrodynamic retarder which can be disengaged mechanically, can be integrated in particularly cost efficient manner in its system environment into the motor vehicle drive train, which can be retrofitted easily and without substantial intervention.

The object of the invention is satisfied with motor vehicle drive train exhibiting the features of claim 1. Advantageous and particularly appropriate embodiments of the invention are disclosed in the dependent claims.

A motor vehicle drive train according to the invention includes a drive motor and drive wheels, whereas the drive wheels are driven by the drive motor via a main branch. A hydrodynamic retarder is provided moreover, comprising a rotating rotor and a stator or a rotating rotor and a counter-rotor rotating in opposite direction to the rotor, which together form a working chamber which is filled or can be filled with a working medium. A separating clutch is provided by means of which the rotor of the hydrodynamic retarder and in the presence of a counter-rotating retarder, in particular the counter-rotor, can be disengaged from a driving power flow in the drive train.

According to the invention the hydrodynamic retarder is connected to the main branch via an at least two-stage transmission (two-stage gear ratio). The two-stage transmission (gear ratio) comprises at least one intermediate shaft or exactly one intermediate shaft and one rotor shaft, whereas the rotor shaft drives or carries the rotor and the intermediate shaft with the main branch forms at least one first or exactly a first gear ratio and with the rotor shaft at least one second or exactly a second gear ratio. According to the invention, the separating clutch is positioned on the intermediate shaft. The hydrodynamic retarder is hence placed at least two gear ratios away from the main branch in other words, the intermediate shaft is placed least one first gear ratio away from each position of the main branch and the retarder is at least one first and one second gear ratio away.

By separating clutch should be understood here every component which in a first operating mode creates a power transmission, in particular a mechanical power transmission and in a second operating mode interrupts said transmission, consequently for instance synchronous elements, friction clutches and others.

In an embodiment according to the invention it is provided that indeed only one intermediate shaft is provided which however forms two selectively actuable gear ratios with the main branch and/or the rotor shaft. To do so, a separating clutch can for instance be provided in the form of a double-acting sliding sleeve which in a first position mechanically connects the first gear ratio, which in a second position mechanically connects the second gear ratio and in a third position, so-called intermediate position, mechanically disconnects both gear ratios.

It is also possible to position and optionally to connect two separating clutches, in particular one beside another, by way of example on both sides of a pinion of the intermediate shaft enclosed therebetween, on the intermediate shaft, so that the first gear ratio is actuated mechanically in a first switching mode with the first separating clutch closed and a second separating clutch open, the second gear ratio is actuated mechanically in a second switching mode with the first separating clutch open and a second separating clutch closed and in a third switching mode, in which both separating clutches are open, both gear ratios and hence the rotor shaft are disconnected mechanically.

The intermediate shaft can be designed, in particular for housing said at least one separating clutch, in several parts, usually with sections flush-mounted relative to one another.

An embodiment according to the invention provides that the motor vehicle drive train exhibits a range change transmission or a continuously variable transmission with a transmission housing. The main branch, by means of which the driving power is transferred from the drive motor to the drive wheels, is constituted partially of said transmission. In detail, the main branch runs from the drive motor via a transmission input shaft, a transmission output shaft et further to the drive wheels. The intermediate shaft can only be in driving connection, with a auxiliary power take off of the transmission, i.e. with a shaft, which is provided in the driving power flow in parallel and in particular physically parallel to the main branch, in particular to the transmission input shaft or the transmission output shaft, by way of example via a spur wheel toothing, or even form said auxiliary power take off.

The hydrodynamic retarder includes in an embodiment according to the invention, which makes use in particular of the connection mentioned above for the range change transmission or the continuously variable transmission, or in which a connection is provided with a housing of the drive motor, a retarder housing which surrounds or forms the rotor and the stator or the rotor and the counter-rotor, moreover surrounds the rotor shaft and at least one portion of the intermediate shaft as well as the separating clutch and exhibits a drive opening via which a driving connection can be established to the intermediate shaft from outside the retarder housing, in particular by means of a toothed gear, which meshes on the intermediate shaft with a pinion. The retarder housing can hence be inserted advantageously into the transmission housing or the housing of the drive motor to establish the driving connection, or connected thereto from the outside. An embodiment thus provides that the intermediate shaft is mounted completely in the retarder housing. Another embodiment provides that one end of the intermediate shaft is mounted in the transmission housing or in the housing of the drive motor. Further embodiments are possible.

The hydrodynamic retarder should suitably include a braking torque control device by means of which different braking torque ratios or braking torque values of the hydrodynamic retarder can be controlled, whereas the braking torque ratios normally include at least two or more stages with a different braking torque as well as a switch-off stage (in the switched off state). The same braking torque control device can be set up also to control the opening and closing of the separating clutch. By way of example, the braking torque control device generates a control pressure according to an actuation of a input device by the vehicle driver, by means of which the vehicle driver commands a braking torque stage of the retarder, or according to an input value of a driver assistance system, such as braking assistance system or an active cruise control of the vehicle. Said control pressure can then be considered similarly for closing and opening said at least one separating clutch. In particular if the separating clutch is designed as a sliding sleeve its axial position is set according to the control pressure or by providing several separating clutches, the first separating clutch is open at the first control pressure and the second is closed, the second separating clutch is open at a second control pressure and the first is closed, and at a third control pressure, both separating clutches are open.

The embodiment according to the invention enables a suitable integration of a retarder, which can be disengaged mechanically, into an existing motor vehicle drive train. Moreover, the different gear ratios can be switched easily. The solution according to the invention offers the advantage of a self-sustained design, which can easily replace existing, non-disconnectable retarders It is hence possible for instance to configure the retarder circuit as such in a more cost efficient manner, in terms of the measures taken so far to prevent ventilation losses in non-braking mode, by way of example without double-acting sliding ring seal for sealing the rotor shaft against the retarder housing, without an emptying pump and without measures such as a movable blade wheel or a ventilation plate.

The invention will now be described by way of example using an embodiment. The figures are as follows:

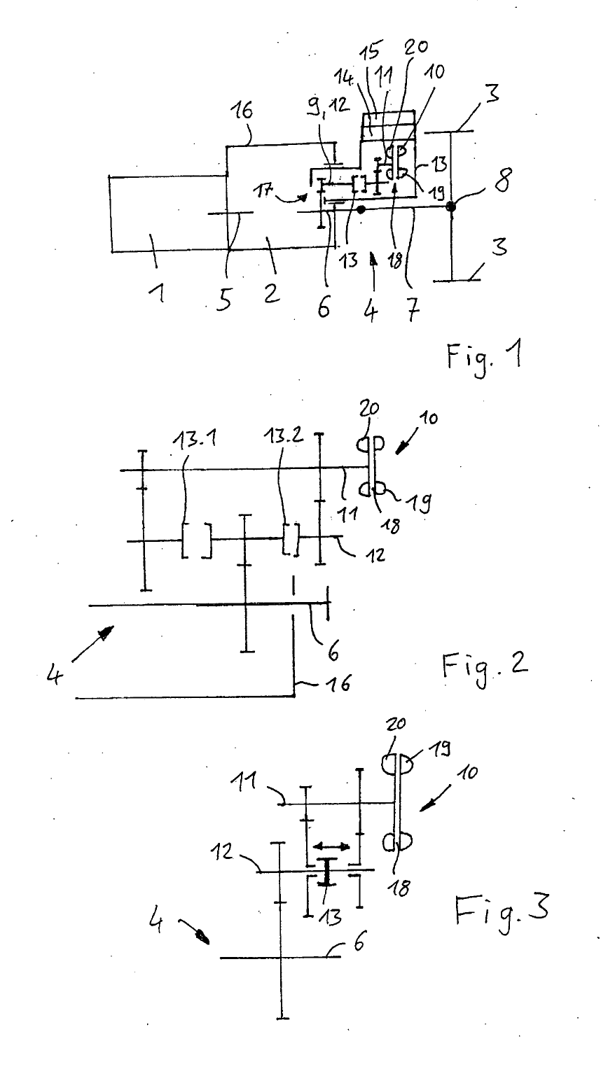

FIG. 1 shows a solution with insertion for a hydrodynamic retarder which can be disengaged mechanically according to the invention;

FIG. 2 shows an embodiment with two separating clutches;

FIG. 3 shows an embodiment with a sliding sleeve acting on both sides.

FIG. 1 represents schematically a motor vehicle drive train according to the invention having a drive motor 1, a transmission 2, in particular a range change transmission or a continuously variable transmission, as well as drive wheels 3 driven by the drive motor 1 via the transmission 2. The main branch 4 of the motor vehicle drive train runs consequently from the drive motor 1 via a transmission input shaft 5, a transmission output shaft 6 and usually a cardan shaft 7 on a differential gear 8 to the driven wheels 3.

The transmission 2 includes a auxiliary power take off on its secondary side with an auxiliary power take off shaft 9, which is in driving connection with the transmission output shaft 6 via a pair of spur wheels. The auxiliary power take off shaft 9 is simultaneously the intermediate shaft 12 of the connection according to the invention in terms of linkage of the hydrodynamic retarder 10 or its rotor shaft 11.

The intermediate shaft 12 includes a separating clutch 13 which in a first switching mode establishes the driving connection with the hydrodynamic retarder 10 and interrupts the driving connection in a second switching mode. The intermediate shaft 12 is in driving connection on its secondary side with the rotor shaft 11 via a pair of spur wheels.

Consequently, a two-stage gear ratio is formed starting from the main branch 4 to the hydrodynamic retarder 10, namely with a first gear ratio, constituted by the driving connection of the first pair of spur wheels of the transmission output shaft 6 and of the auxiliary power take off shaft 9 (intermediate shaft 12) and a second gear ratio, constituted by the driving connection of the pair of spur wheels of the intermediate shaft 12 and of the rotor shaft 11.

The hydrodynamic retarder 10 has a retarder housing 13, which is inserted with one end into the transmission housing 16. A drive opening 17 is provided to establish a driving connection with the toothed gear on the transmission output shaft 6.

The retarder 10 comprises moreover a radiator 14 as well as a braking torque control device 15. The absorbed heat is discharged from the working medium by means of the radiator 14 in the working chamber 18, formed by the rotor 20 and the stator 19. The braking torque control device 15 controls the braking torque outputted from the retarder 10.

In the embodiment according to FIG. 2, the intermediate shaft 12 includes two separating clutches 13.1 and 13.2. Moreover, the intermediate shaft 12 is in driving connection via a first gear ratio with the transmission output shaft 6 and hence the main branch 4. The intermediate shaft 12 is in driving connection with the rotor shaft 11 via two second gear ratios, which could be defined as second and third gear ratios. Each of both “second’ gear ratios is formed by a pair of spur wheels which both pairings include gear ratios which are different from each other. The first pair of spur wheels can be actuated and deactuated mechanically by means of the first separating clutch 13.1. The second pair of spur wheels can be actuated and deactuated mechanically by means of the second separating clutch 13.2. It goes without saying that also other driving connections could be considered as pairs of spur wheels, for example belt drives or other gear trains.

According to the embodiment variation and FIG. 2, the rotor 20 of the hydrodynamic retarder 19 can hence selectively be driven with one of two gear ratios so that the ratio of the rotational speed between the transmission output shaft 6 and the rotor 20 can be modified.

In the embodiment according to FIG. 3, the same action mode as in the embodiment according to FIG. 2 can be achieved with only one separating clutch 13. Said separating clutch is designed as a sliding sleeve and establishes in a first switching position a driving connection via the first spur wheel gear between the intermediate shaft 12 and the rotor shaft 11, in a second switching position between the intermediate shaft 12 and the rotor shaft 11 via the second spur wheel gear and in a third switching position (middle position) it interrupts the driving connection between the intermediate shaft 12 and the rotor shaft 11.

1. Motor vehicle drive train
having a drive motor and drive wheels, whereas
the drive wheels are driven by the drive motor via a main branch;
having a hydrodynamic retarder, comprising a rotating rotor and a stator or a rotating rotor and a counter-rotor rotating in opposite direction to the rotor, which together form a working chamber which is filled or can be filled with a working medium;
having a separating clutch, by means of which the rotor of the hydrodynamic retarder can be disengaged from a driving power flow in the drive train; characterised in that
the hydrodynamic retarder is connected to the main branch via an at least two-stage transmission, comprising at least one intermediate shaft and a rotor shaft, whereas the rotor shaft drives or carries the rotor and the intermediate shaft with the main branch forms at least one first transmission ratio and with the rotor shaft at least one second transmission ratio, and the separating clutch is positioned on the intermediate shaft.

2. Motor vehicle drive train according to claim 1, characterised in that the transmission ratio is exactly in two stages with a single intermediate shaft.

3. Motor vehicle drive train according to claim 1, characterised in that the intermediate shaft is in driving connection with the main branch and/or the rotor shaft via two selectively switchable gear ratios with multiplication ratios which are different from each other.

4. Motor vehicle drive train according to claim 3, characterised in that the different gear ratios are switchable by means of different switching states of the separating clutch, which is designed in particular as a sliding sleeve.

5. Motor vehicle drive train according to claim 3, characterised in that two separating clutches, which in particular are designed as sliding sleeves, are arranged on the intermediate shaft, whereas the first gear ratio can be activated by closing the first separating clutch and the second gear ratio can be activated by closing the second separating clutch.

6. Motor vehicle drive train according to claim 1, characterised in that the motor vehicle drive train exhibits a range change transmission or a continuously variable transmission with a transmission housing, whereas the main branch runs from the drive motor via a transmission input shaft of the range change transmission or a continuously variable transmission to a transmission output shaft and then further to the drive wheels, and the intermediate shaft is linked to a auxiliary power take off of the range change transmission or a continuously variable transmission or of the drive motor or forms such a power take off.

7. Motor vehicle drive train according to claim 6, characterised in that the hydrodynamic retarder has a retarder housing which surrounds or forms the rotor and the stator or the rotor and the counter-rotor, moreover surrounds the rotor shaft and at least one portion of the intermediate shaft as well as the separating clutch and exhibits a drive opening via which a driving connection can be established to the intermediate shaft from outside the retarder housing, in particular by means of a toothed gear, which meshes on the intermediate shaft with a pinion, and the retarder housing can be inserted into the transmission housing or a housing of the drive motor to establish the driving connection and/or said retarder housing can be connected to said gear housing.

8. Motor vehicle drive train according to claim 1, characterised in that the hydrodynamic retarder includes a braking torque control device by means of which different braking torque ratios or braking torque values of the hydrodynamic retarder can be controlled, and the braking torque control device also operates the opening and closing of said at least one separating clutch.

9. Motor vehicle drive train according to claim 2, characterised in that the intermediate shaft is in driving connection with the main branch and/or the rotor shaft via two selectively switchable gear ratios with multiplication ratios which are different from each other.

10. Motor vehicle drive train according to claim 2, characterised in that the motor vehicle drive train exhibits a range change transmission or a continuously variable transmission with a transmission housing, whereas the main branch runs from the drive motor via a transmission input shaft of the range change transmission or a continuously variable transmission to a transmission output shaft and then further to the drive wheels, and the intermediate shaft is linked to a auxiliary power take off of the range change transmission or a continuously variable transmission or of the drive motor or forms such a power take off.

11. Motor vehicle drive train according to claim 3, characterised in that the motor vehicle drive train exhibits a range change transmission or a continuously variable transmission with a transmission housing, whereas the main branch runs from the drive motor via a transmission input shaft of the range change transmission or a continuously variable transmission to a transmission output shaft and then further to the drive wheels, and the intermediate shaft is linked to a auxiliary power take off of the range change transmission or a continuously variable transmission or of the drive motor or forms such a power take off.

12. Motor vehicle drive train according to claim 4, characterised in that the motor vehicle drive train exhibits a range change transmission or a continuously variable transmission with a transmission housing, whereas the main branch runs from the drive motor via a transmission input shaft of the range change transmission or a continuously variable transmission to a transmission output shaft and then further to the drive wheels, and the intermediate shaft is linked to a auxiliary power take off of the range change transmission or a continuously variable transmission or of the drive motor or forms such a power take off.

13. Motor vehicle drive train according to claim 5, characterised in that the motor vehicle drive train exhibits a range change transmission or a continuously variable transmission with a transmission housing, whereas the main branch runs from the drive motor via a transmission input shaft of the range change transmission or a continuously variable transmission to a transmission output shaft and then further to the drive wheels, and the intermediate shaft is linked to a auxiliary power take off of the range change transmission or a continuously variable transmission or of the drive motor or forms such a power take off.

14. Motor vehicle drive train according to claim 2, characterised in that the hydrodynamic retarder includes a braking torque control device by means of which different braking torque ratios or braking torque values of the hydrodynamic retarder can be controlled, and the braking torque control device also operates the opening and closing of said at least one separating clutch.

15. Motor vehicle drive train according to claim 3, characterised in that the hydrodynamic retarder includes a braking torque control device by means of which different braking torque ratios or braking torque values of the hydrodynamic retarder can be controlled, and the braking torque control device also operates the opening and closing of said at least one separating clutch.

16. Motor vehicle drive train according to claim 4, characterised in that the hydrodynamic retarder includes a braking torque control device by means of which different braking torque ratios or braking torque values of the hydrodynamic retarder can be controlled, and the braking torque control device also operates the opening and closing of said at least one separating clutch.

17. Motor vehicle drive train according to claim 5, characterised in that the hydrodynamic retarder includes a braking torque control device by means of which different braking torque ratios or braking torque values of the hydrodynamic retarder can be controlled, and the braking torque control device also operates the opening and closing of said at least one separating clutch.

18. Motor vehicle drive train according to claim 6, characterised in that the hydrodynamic retarder includes a braking torque control device by means of which different braking torque ratios or braking torque values of the hydrodynamic retarder can be controlled, and the braking torque control device also operates the opening and closing of said at least one separating clutch.

19. Motor vehicle drive train according to claim 7 characterised in that the hydrodynamic retarder includes a braking torque control device by means of which different braking torque ratios or braking torque values of the hydrodynamic retarder can be controlled, and the braking torque control device also operates the opening and closing of said at least one separating clutch.
